(19) United States
(12) Patent Application Publication
(10) Pub. No.: US 2004/0143045 A1
(43) Pub. Date: Jul. 22, 2004

(54) Ignition resistant polymeric composite

(76) Inventors: Alexander B. Morgan, Midland, MI (US); Che-I Kao, Houston, TX (US); Ing-Feng Hu, Midland, MI (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/731,546

(22) Filed: Dec. 9, 2003

Related U.S. Application Data
(60) Provisional application No. 60/433,266, filed on Dec. 13, 2002.

(51) Int. Cl. C08K 5/49; B32B 27/00

(52) U.S. Cl. 524/115; 428/425.5

(57) ABSTRACT

The present invention is an ignition resistant polymeric composite comprising a) a polymeric substrate; b) a flame retardant intermixed with the polymeric substrate; and c) a partially oxidized plasma polymerized organosilicon layer adhered to the substrate. The ignition resistant composite can readily achieve a V-0 rating in a UL-94 flammability test using a substantially lower concentration of flame retardant than is commonly incorporated into substrates to achieve the same result. Consequently, the present invention addresses the need to maintain the integrity of a substrate incorporated with flame retardant to reduce the levels of environmentally suspect materials.

### CROSS-REFERENCE STATEMENT

This application claims the benefit of U.S. Provisional Application No. 60/433,266, filed Dec. 13, 2002.

### BACKGROUND OF THE INVENTION

Polymers are commonly used for a variety of applications where compliance with ignition-resistance standards is required. For example, the electronic enclosure industry requires that computer casings and monitor and cell-phone housings must pass the Underwriters Laboratories UL-94 test. (“Standard for Tests for Flammability of Plastic Materials for Parts in Devices and Appliances”, 5^{th} Ed., Research Triangle Park, NC, Underwriters Laboratories, Inc., 1998.) To comply with industry standards, polymers are routinely treated with non-halogenated flame retardants such as phosphates. However, phosphates, though effective non-halogenated flame retardants, are costly and tend to weaken the mechanical properties of the polymeric substrate.

Flame retardancy can also be achieved by applying an ignition resistant silicon-based coating onto the surface of the substrate. For example, Jama et al. describe in an ACS Symposium paper (“Fire Retardancy and Thermal Stability of Materials Coated by Organosilicon Thin Films Using a Cold Remote Plasma Process”, in “Fire and Polymers: Materials and Solutions for Hazard Prevention,” Ed. Nelson, G. L.; Wilkie C. A.; ACS Symposium Series #797, ACS publishing/Oxford University Press, 2001) a way to achieve enhanced ignition resistance of a polyamide-6 plastic substrate containing a polyamide-6 clay nanocomposite by depositing a silicon oxide coating onto the substrate using cold remote nitrogen plasma. However, there is no indication that a substrate treated in the fashion described by Jama et al. would achieve a V-0 rating in the UL-94 flammability test.

Accordingly, it would be desirable to impart ignition resistance onto a plastic substrate by using lesser amounts of the costly and mechanical destabilizing phosphate flame retardant.

### SUMMARY OF THE INVENTION

The present invention addresses a need in the art by providing an ignition resistant polymeric composite comprising, a) a polymeric substrate; b) a flame retardant intermixed with the polymeric substrate; and c) a partially oxidized plasma polymerized organosilicon layer adhered to the substrate.

In a second aspect, the present invention is an ignition resistant polymeric composite comprising, a) a polycarbonate/ABS substrate; b) a phosphate flame retardant intermixed with the substrate; c) a partially oxidized plasma polymerized organosilicon layer adhered to the substrate; and d) a surface pretreatment layer that promotes adhesion of the partially oxidized plasma polymerized organosilicon layer to the substrate.

The composite of the present invention provides ignition resistance capable of attaining a V-0 rating in a UL-94 flammability test while using reduced amounts of flame retardant incorporated into the substrate. Among the uses of the composite include electronic enclosure applications such as casings for cell phones, calculators, computers, television sets, DVD players, CD players, monitor housings, and in general, any electrical appliance needing external or internal ignition resistant plastic components.

### DETAILED DESCRIPTION OF THE INVENTION

The polymeric composite of the present invention resists ignition by virtue of flame retardant incorporated into the substrate combined with a protective partially oxidized plasma polymerized organosilicon layer over the substrate. As used herein, the term “partially oxidized” means that the resultant layer is not oxidized to the degree ordinarily associated with what is necessary to create a silicon oxide (SiOₓ) layer.

The substrate can be any polymeric material including a polystyrene, an ABS (an acrylonitrile-butadiene-styrene block copolymer), a polycarbonate, a copolymer blend of a polycarbonate and an ABS, a thermoplastic polyurethane, a thermoset polyurethane, a polyetherimide, a polyamide, a polyaramid, a polyetheretherketone, a polysulfone, a polylactic acid, an epoxy laminate, a vinyl ester laminate, a cyanate ester composite, a polyolefin such as a polyethylene, a polypropylene, an ethylene-vinyl acetate copolymer (EVA), or an ethylene-α-olefin copolymer, a rubber such as a polybutadiene or a polyisoprene, a polyvinyl chloride, or a terephthalate such as a polyethylene terephthalate or a polybutylene terephthalate.

If the substrate is thermoplastic, the flame retardant is advantageously incorporated into the polymeric substrate by melt compounding, preferably by twin screw extrusion. If the substrate is a thermoset, the flame retardant is advantageously incorporated into a monomer or prepolymer of the polymer prior to complete polymerization and curing.

The amount of flame retardant used is substrate and application dependent, but is preferably not more than 15%, more preferably not more than 10%, and most preferably not more than 7% by weight, based on the weight of flame retardant and the substrate. Examples of classes of flame retardants include phosphates, halogenated compounds, and antimony oxides (particularly when used in combination with halogenated compounds, with phosphates being preferred. Examples of suitable phosphates can be found in U.S. Pat. No. 6,369,141 B1, column 5, lines 1-67 to column 6, lines 1-21, and U.S. Pat. No. 6,403,683 B1, column 7, lines 37-67 to column 8, lines 1-19, which teachings are incorporated herein by reference. Examples of preferred phosphates include resorcinol bis(dixylenyl phosphate) (commercially available as FP-500 by Asahi Denko Kogyo K.K.), bisphenol A diphosphate, and triphenyl phosphate.

In addition to flame retardant, other materials are advantageously incorporated into substrate (all percentages based on the weight of the substrate and the additives) including a) an impact modifying amount of an impact modifier, preferably from 1 to 10 weight percent of an elastomer such as a methacrylate-based core-shell graft copolymer, a polyurethane-based elastomer, or a polyester-based elastomer; b) an effective amount of an anti-drip agent, preferably from 0.05 to 5 weight percent of a mixture of a polytetrafluroethylene having fibril formability such as Metabrene A3000 (Mitsubishi Rayon Co., Ltd) or Teflon 6C polytetrafluroethylene (E. I. du Pont de Nemours & Co.); c) an effective amount of a mold release agent, preferably from 0.1 to 2 weight percent of an emulsifier such as Alkamus J K emulsifier; d) a stabilizing amount of a thermal stabilizer preferably from 0.01 to 0.1 weight percent of an epoxidized soybean oil; and an effective amount of an antioxidant, preferably from 0.05 to 1 percent of a hindered phenol antioxidant such as Irganox 1076 antioxidant (Ciba-Geiby Corp.) After flame retardant and ancillary components are admixed with the polymeric substrate (or monomer for a thermoset substrate), the ignition resistant substrate is preferably molded into a finished part before being coated with the partially oxidized plasma polymerized organosilicon layer. This layer provides a barrier to oxygen as well as thermo-mechanical stability, thereby reducing the amount of flame retardant required to attain a V-0 rating in a UL-94 flammability test.

Deposition of the partially oxidized plasma polymerized organosilicon layer may be carried out using techniques and equipment well known in the art of PECVD such as those described in U.S. Pat. Nos. 5,298,587 and 5,320875, which are incorporated herein by reference. Preferably, the partially oxidized plasma polymerized organosilicon layer has the formula SiOₓC_{y}H_{z}, where x is not less than 1.0, more preferably not less than 1.8, and preferably not greater than 2.4; y is not less than 0.2, more preferably not less than 0.3, and preferably not greater than 1.0; and z is greater than or equal to 0, more preferably not less than 0.7, and preferably not greater than 4.0.

A surface pretreatment layer (also known as an adhesion promoter layer) is preferably deposited onto the ignition resistant substrate prior to deposition of the partially oxidized plasma polymerized organosilicon layer to further promote adhesion of the partially oxidized plasma polymerized organosilicon layer to the ignition resistant substrate, thereby further increasing thermo-mechanical stability. The surface pretreatment layer is typically formed by either of 1) plasma treatment of the substrate in the presence of oxygen- or nitrogen-containing molecules such as air, O₂, N₂, water, NH₃, NO₂, N₂O, and the like, or 2) plasma polymerization of an organosilicon compound such as those described in U.S. Pat. No. 5,718,967, column 3, lines 43-57, incorporated herein by reference. Surface treatment in the presence of oxygen- or nitrogen-containing molecules is preferred for non-polar substrates such as polyolefins and polystyrenes while surface treatment by plasma polymerization of an organosilicon is preferred for more polar substrates such as ABS, polycarbonates, ABS/polycarbonate blends, polyalkylene terephthalates, polyurethanes.

Surface pretreatment prepared by plasma polymerization of an organosilicon compound is carried out using a stoichiometric excess of the organosilicon compound with respect to oxygen, preferably using the organosilicon compound in the absence of oxygen, and at power levels sufficient to create an interfacial chemical reaction for adhesion, as described in U.S. Pat. No. 5,718,967, column 2, lines 44-67, column 5, lines 62-67 and column 6, lines 1-9, which teachings are incorporated herein by reference. The thickness of the surface pretreatment layer is application dependent and is preferably not less than about 50 Å, more preferably not less than about 500 Å, and most preferably not less than about 1000 Å thick; and preferably not more than 10,000 Å, more preferably not more than 5000 Å, and most preferably not more than 2000 Å thick.

The coated ignition resistant substrate may also contain an SiOₓ layer superposing the partially oxidized plasma polymerized organosilicon layer to provide a further barrier to oxygen, thereby increasing the ignition resistance of the composite. The SiOₓ layer preferably contains no carbon or hydrogen atoms but may contain residual amounts of each, preferably not more than 1 carbon atom per 20 oxygen atoms, more preferably not more than 1 carbon atom per 50 oxygen atoms, and not preferably more than 1 hydrogen atom per 4 oxygen atoms. The SiOₓ layer, where x is preferably in the range of 1.6 to 2.0, may be formed by any of a number of techniques including PECVD, thermal evaporation, sputtering, and atomic layer deposition, with PECVD being preferred. For PECVD, an organosilicon compound is advantageously polymerized in the presence of a stoichiometric excess of oxygen with respect to the oxidizable atoms in the organosilicon compound and preferably at a power density of at least twice, more preferably at least four times, and most preferably at least six times the power density used to form the partially oxidized plasma polymerized organosilicon layer.

The thickness of the SiOₓ layer is application and substrate dependent, but is typically thinner than the partially oxidized plasma polymerized organosilicon layer. Preferably the SiOₓ layer is not less than about 100 Å, more preferably not less than about 500 Å, and most preferably not less than about 1000 Å thick; and preferably not more than 50,000 Å, more preferably not more than 10,000 Å, and most preferably not more than 5,000 Å thick.

The ignition resistant composite of the present invention can readily achieve a V-0 rating in a UL-94 flammability test using a substantially lower concentration of flame retardant than is commonly incorporated into substrates to achieve the same result. Consequently, the present invention addresses the need to maintain the integrity of a substrate incorporated with flame retardant to reduce the levels of environmentally suspect materials.

The following example is for illustrative purposes only and is not intended to limit the invention in any way.

### EXAMPLE

### Preparation of an Ignition Resistant PC/ABS Substrate Coated with a Partially Oxidized Plasma Polymerized Organosilicon Layer

PC/ABS formulation—A PCS/ABS blend is formulated by twin screw extrusion as illustrated in Table 1 to form an ignition resistant substrate.

| Raw Materials | Weight Percent |
|---|---|
| Calibre 200-22 Polycarbonate | 76.91 |
| ABS Resin | 14.74 |
| FP-500 flame retardant | 5.5 |
| Paraloid EXL-3691A MBS impact modifier | 2.0 |
| Teflon 6C perfluoroethylene | 0.4 |
| Alkamuls JK mold release agent | 0.2 |
| Irganox 1076 antioxidant | 0.2 |
| Epoxidized Soybean Oil | 0.05 |

The surfaces of the formulated substrate are then cleaned with isopropyl alcohol, then subjected to vapor phase polymerization by PECVD using equipment described in U.S. Pat. No. 5,900,284, incorporated herein by reference. The electrodes are parallel to each other and 1 foot (0.3 m) apart, powered with an AC power supply at 110 kHz, using a plasma power of 750 W. Tetramethyldisiloxane is flowed at 44 sccm and oxygen flowed at 35 sccm to deposit a 3-μm thick partially oxidized plasma polymerized layer.

A UL-94 test is performed on a 125-mm×13-mm×13-mm sample suspended vertically above a cotton patch. The substrate is subjected to two 10-second flame exposures with a calibrated flame in a unit which is free from the effects of external air currents. After the first 10-second exposure, the flame is removed, and the time for the sample to self-extinguish recorded. The second ignition is then performed on the same sample and the self-extinguishing time and dripping characteristics recorded. The substrate self-extinguishes in less than 10 seconds after each ignition, with no dripping, indicating a V-0 performance.

What is claimed is:

1. An ignition resistant polymeric composite comprising, a) a polymeric substrate; b) a flame retardant intermixed with the polymeric substrate; and c) a partially oxidized plasma polymerized organosilicon layer adhered to the substrate.

2. The ignition resistant polymeric composite of claim 1 wherein the polymeric substrate is selected from the group consisting of a polystyrene, an ABS, a polycarbonate, a copolymer blend of a polycarbonate and an ABS, a thermoplastic polyurethane, a thermoset polyurethane, a polyetherimide, a polyamide, a polyaramid, a polyetheretherketone, a polysulfone, a polylactic acid, an epoxy laminate, a vinyl ester laminate, a cyanate ester composite, a polyolefin, a rubber, a polyvinyl chloride, and a terephthalate.

3. The ignition resistant polymeric composite of claim 2 wherein the plastic substrate is a copolymer blend of a polycarbonate and an ABS.

4. The ignition resistant polymeric composite of claim 3 wherein the flame retardant is an ignition resistant phosphate compound.

5. The ignition resistant polymeric composite of claim 4 wherein the partially oxidized plasma polymerized organosilicon layer adheres to the substrate by way of a surface pretreatment layer.

6. The ignition resistant polymeric composite of claim 5 wherein the surface pretreatment layer is formed by either of 1) plasma pretreatment of the substrate in the presence of oxygen- or nitrogen-containing molecules or 2) plasma polymerization of an organosilicon compound using a stoichiometric excess of the organosilicon compound with respect to oxygen.

7. The ignition resistant polymeric composite of claim 6 wherein the surface pretreatment layer is formed by plasma polymerization of an organosilicon compound in the absence of oxygen.

8. The ignition resistant polymeric composite of claim 4 wherein the concentration of the ignition resistant phosphate compound is not greater than 10% by weight, based on the weight of the phosphate and the plastic substrate.

9. The ignition resistant polymeric composite of claim 5 wherein the concentration of the ignition resistant phosphate compound is not greater than 7.5% by weight, based on the weight of the phosphate and the plastic substrate.

10. The ignition resistant polymeric composite of claim 7 wherein concentration of the ignition resistant phosphate compound is not greater than 5.5% by weight, based on the weight of the phosphate and the plastic substrate.

11. An ignition resistant polymeric composite comprising, a) a substrate containing a blend of a polycarbonate and an ABS; b) a phosphate flame retardant intermixed with the plastic substrate; c) partially oxidized plasma polymerized organosilicon layer adhered to the substrate; and d) a surface pretreatment layer that promotes adhesion of the partially oxidized plasma polymerized organosilicon layer to the substrate.

12. The ignition resistant polymeric composite of claim 11 wherein the phosphate flame retardant is selected from the group consisting of resorcinol bis(dixylenyl phosphate), bisphenol A diphosphate, and triphenyl phosphate.

13. The ignition resistant polymeric composite of claim 11 wherein the substrate contains from 60% to 90% of the polycarbonate by weight and from 10% to 40% of the ABS by weight, based on the weight of the polycarbonate and the ABS.

14. The ignition resistant polymeric composite of claim 13 wherein the partially oxidized plasma polymerized organosilicon layer has the formula SiOₓC_{y}H_{z}, where x is not less than 1.0; y is not less than 0.2; and z is greater than or equal to 0.

15. The ignition resistant polymeric composite of claim 13 which further includes an SiOₓ layer superposing the partially oxidized plasma polymerized organosilicon layer, wherein x is in the range of 1.6 to 2.0.

16. The ignition resistant polymeric composite of claim 11 which is an enclosure for a computer casing, a monitor housing, a calculator, a cell phone, a television set, a DVD player, or a CD players.
